(19) United States
(12) Patent Application Publication
(10) Pub. No.: US 2002/0005439 A1
(43) Pub. Date: Jan. 17, 2002

(54) Configured nozzle system for marine application of chemical dispersant on oil spills

(76) Inventor: David C. Kendall, Houston, TX (US)

Correspondence Address: Williams & Associates, Suite 300, 1030 Fifteenth Street, N.W., Washington, DC, 20005-1501, US

(21) Appl. No.: 09/848,876

(22) Filed: May 4, 2001

Related U.S. Application Data
(63) Continuation-in-part of application No. 09/407,045, filed on Sep. 27, 1999, now abandoned.

(51) Int. Cl. B05B 3/10

(52) U.S. Cl. 239/223

(57) ABSTRACT

An apparatus and method for applying undiluted chemical dispersant to a waterborne oil spill using a gentle uniform rain producing nozzle consisting of a rotating element having teeth to break up the fluid stream in to gentle uniform rain-sized droplets having a minimum diameter for uniform dispersal over a wide area. The novelty of this invention is that it is the only neat spray dispersant apparatus and method specifying dispersal through a moving element configured nozzle having an adjustable flow rate. The apparatus is skid mounted and portable. It comprises a pump to suction dispersant from tanks or other receptacles where it is stored and pressurize the dispersant, a pressure manifold that allows the dispersant to pressurize and a monitor or hose attachment hydraulically connecting the pressure manifold to one or more configured nozzles that distribute the chemical dispersant upon the oil spill. The method comprises pressurizing dispersant and spraying it through a configured nozzle onto the oil spill.

### FIELD OF INVENTION

This invention relates to oil spill removal in the marine environment. More particularly, it relates to a system for treating oil spills on navigable bodies of water using chemical dispersants. It further relates to treating such oil spills using undiluted, or neat, chemical dispersants.

### BACKGROUND OF THE INVENTION

Any discharge of a significant amount of oil into the marine environment will trigger a response effort to recover or dissipate the spilled oil. Although mechanical recovery of the oil is the primary means of removing large quantities of spilled oil, application of chemical dispersants is an important supplementary measure for spills that spread over a wide area or create a large slick. In particular, dispersants remove oil from the surface of the water by chemical and physical processes such as emulsification, and distribute it throughout the water column, where it is diluted by currents and biodegrade into harmless substances. Dispersants are particularly helpful in preventing oil from stranding on the shoreline, where it can damage coastal habitats and resident wildlife.

Recognition of the real-world geometry of an oil spill is important to the effectiveness of treatment with chemical dispersants. Most dispersant application systems assume the spill to be of a uniform thickness of about 0.10 to 0.20 millimeters (100 to 200 microns). However, in actuality the distribution of oil is much more likely to be lens-shaped, with the thickest areas at or near the center of the spill area. One or more areas of thick oil (usually thicker than 1 millimeter) will contain most of the volume of the oil spilled, and these thick areas will be surrounded by much larger areas of very thin oil or sheen having a thickness of about 1 to 10 microns. As a rule of thumb, 90 to 95 percent of the total spill volume is contained in 5 to 10 percent of the spill area. Thus, an efficient dispersant application system is able to concentrate dispersant where the oil is thickest without degrading its ability to treat large spill areas.

Dispersants are of three types: water-soluble dispersants; hydrocarbon solvent-based dispersants (typically having between 10 and 30 percent surfactant in a hydrocarbon solvent such as kerosene); and concentrated dispersants (typically having between 30 and 80 percent surfactant in oxygenated solvents or hydrocarbon solvents). All three types of dispersants may be applied neat—that is, undiluted—and, in addition, water-based dispersants and concentrated dispersants may be diluted with seawater prior to application.

Application of neat dispersant is generally regarded as the most effective approach and is the preferred method. Dilute application is frequently wasteful of dispersant because the application systems tend to drive dispersant through the oil at high velocity rather than allowing it to fall gently on the oil surface, where it is most effective. However, until the present invention, hydraulic systems for effectively and efficiently applying neat dispersant to oil spills have been lacking.

Dispersant application systems should spray in an even distribution. The size and uniformity of spray droplets are also important to effective application. Specifically, application is more effective if the spray droplets are small enough to fall gently onto the surface of the oil slick without penetrating the oil and passing into the water column. However, where the droplet size is too small, the dispersant tends to mist and be carried away by the wind. The most desirable spray pattern allows the dispersant to fall vertically to the water's surface as a gentle uniform rain (as defined below), closely akin to a “drizzle,” so that the dispersant can settle lightly on the oil release the surface tension of the oil.

With respect to droplet size distribution for application of liquids, recently the Ohio State University Extension Division published Bulletin 816-00 (available on the Internet at www.ag.ohio-state.edu/˜ohioline/b816/b816_{—}10.html). Although this reference relates to spraying agricultural substances such as insecticide and fertilizer, the atmospheric and meteorological physics it describes or references is relevant to the invention of this application. The section entitled “Droplet Size” describes the effect of droplet size on the off-target drift of liquid sprays. It indicates, for example, that 20 micron droplets take 4 minutes to fall 10 feet and during that time will drift 1056 feet laterally in a 3 mph wind. Conversely, 400 micron droplets fall 10 feet in 2 seconds and will drift during fall only 9 feet in a 3 mph wind. Particles smaller than about 50 microns tend to remain suspended in air indefinitely until they evaporate. The section of the Bulletin entitled “Spray Pressure” indicates that droplet size is generally inversely proportional to pressure upstream of the nozzle. It further indicates that for effective spraying, minimizing the percentage of droplets smaller in size than 100 microns is highly desirable. The section entitled “Nozzle Type and Size” further emphasizes that nozzle selection is critical to minimizing the fraction of the spray that goes into small droplet sizes and thereby promotes drift. The instant invention is directed to producing such a spray in the context of spraying neat oil dispersant onto oil spills and to specific means for producing the droplet size distribution which minimizes the fraction of droplets smaller in size than 100 microns.

The McGRAw-HILL DICTIONARY OF SCIENTIFIC AND TECHNICAL TERMS (5^{th} Ed. 1994) [hereinafter “McGraw-Hill”] defines “rain” at p. 1646 as “Precipitation in the form of liquid water drops with diameters greater than 0.5 millimeter, or if widely scattered the drops may be smaller; the only other form of liquid precipitation is drizzle.” McGraw-Hill further defines “drizzle” at p. 617 as “Very small, numerous, and uniformly dispersed water drops that may appear to float while following air currents; unlike fog droplets, drizzle falls to the ground. . . . ” (Emphasis added.) On the same page, McGraw-Hill defines “drizzle drop” as “A drop of water of diameter 0.2 to 0.5 millimeter falling through the atmosphere; however, all water drops of diameter greater than 0.2 millimeter are frequently termed raindrops. . . .” On page 786, McGraw-Hill equates “fog drop” to “cloud droplet, and on page 390 defines “cloud droplet” as “A particle of liquid water from a few micrometers to tens of micrometers in diameter, formed by condensation of atmospheric water vapor and suspended in the atmosphere with other drops to form a cloud.” The current invention is directed to excluding, as much as is practicable, fog or cloud droplets from the spray of neat dispersant. This application has previously referred to rain, specifically to a gentle uniform rain. Based on the foregoing discussion of desirable droplet size, this application expands the normal scientific definition of “rain” slightly and uses a definition of “gentle uniform rain” meaning rain, including but not limited to drizzle as defined in the quoted definition from McGraw-Hill, but extending to droplet sizes down to 0.1 millimeter, or 100 microns, in size. This definition is intended to encompass a rain, including drizzle, with particle size distribution with sizes mainly in the range of 100 microns to 500 microns, minimizing as much as is possible with affordable engineering technology droplets less than 100 microns in size. However, this definition does not exclude liquid droplet sizes greater than 500 microns to the extent that the droplets are not so big that they defeat the function of this invention, namely to deposit neat dispersant on top of an oil spill in such a way that the dispersant may interact with the oil physically and chemically so as to cause efficient and effective dispersal of the oil.

It is recognized in this invention that no mechanical means of producing droplets from fluid can perfectly cut off droplet size at 100 microns (or at 500 microns at the high end). Acordingly in this application “gentle uniform rain” means a rain with a droplet size distribution which minimizes as much as is reasonably possible as necessary to achieve the desired result the proportion of droplets with a size less than 100 microns. The proportion of droplets greater than 500 microns is ideally somewhat constrained, but that constraint is not nearly so critical as the minimization at below 100 microns.

In addition, the term “hydraulic” is used extensively in this application. Although there is a tendency to associate the term with water flow, in this application it is used in the wider sense as referring to the flow of any fluid, whether water based or not.

Various means have been used in the past to apply dispersant to large oil spills. Aircraft are often used in treating large spills because they can spray a large area with dispersant relatively quickly. Moreover, as noted below, wind shear acting on fluids released from aircraft tends to produce a desirable particle size distribution. U.S. Pat. No. 4,437,630 teaches one such system for aerial swath spraying of chemical dispersants on ocean oil spills. However, aircraft-based systems exhibit a number of drawbacks. First, it is prohibitively expensive to maintain dedicated large aircraft in readiness, waiting for an oil spill to occur. Thus, considerable time is required for mobilization. A suitable aircraft must be taken out of other service, repositioned, and outfitted with an appropriate dispersant application system. Second, the payload capacity of an airplane is much less than that of a vessel. Aircraft therefore have a limited capacity for dispersant fluids. Third, the aircraft's ability to remain on station for long periods, a function of its fuel capacity, is limited compared to that of a vessel. Fourth, since most of the spill area is covered in sheen, uniform application can be wasteful of dispersant. Fifth, repositioning the aircraft to make multiple passes over areas of thick oil is time consuming.

Waterborne systems on vessels overcome some of the drawbacks of aerial systems. Suitable vessels are more readily available at a lower cost. Although vessels are slower to transit to the spill site than aircraft, they are able to remain on station until the job is done by virtue of having much greater capacities for both fuel and dispersant. Even if a vessel requires additional fuel or dispersant, resupply can be accomplished while the vessel remains on station. Vessels also have the potential to provide greater control and accuracy over dispersant application than an aircraft. Moreover, vessel speed and direction can be adjusted to concentrate treatment with dispersant where it is most needed—on the thick patches—allowing the vessel to treat the spill in one pass, rather than multiple passes as with an aircraft.

There are three principal types of application systems with which dispersant can be sprayed on a spill: boom sprayer systems, ducted-fan air blower systems, and monitor systems. Boom sprayer systems, also known as spray arm systems, are the most common type of spraying system. A boom sprayer consists of one or more pipes deployed over the side of the vessel or suspended from the aircraft.

On a vessel, the spray booms or spray arms extend horizontally from either side of the bow of the vessel. As the vessel moves slowly through the water, dispersant is sprayed from the nozzles onto the water surface. One major drawback of this type of system is that the booms cannot be deployed in rough seas due to the possibility that waves or rolling of the vessel would allow the booms to dip into the water which could damage them. Even when the operating conditions permit, however, the length of the boom, which is limited by the freeboard of the vessel and expected roll of the vessel, sets a relatively narrow sweep width compared to an aircraft.

Another drawback of vessel-based boom application systems has been the need to limit the speed of the vessel to typically between 2 and 10 knots so that the bow wave from the vessel does not wash out the dispersant before it reaches the oil/water interface. Yet another drawback associated with boom sprayer systems is the relatively complex installation required to attach them to the vessel. Not all vessels are suitable for deploying boom sprayers because of their available freeboard. In addition, many of these installations require some modification to the vessel to accommodate the relatively extensive booms, boom supporting structures, and pumping systems.

Boom sprayers used with large aircraft are relatively insensitive to the geometry of the nozzles used since wind shear tends to break the dispersant up into droplets of the desired size. However, in vessel applications of boom sprayers, nozzle geometry is quite important. Booms typically are fitted with multiple small cone, flat, or fan-type nozzles through which the dispersant is sprayed. Rather than being adjustable, boom sprayer nozzles are typically of a fixed geometry. Several sets of nozzles are normally supplied with a given system so the nozzles can be interchanged to suit prevailing conditions at a particular spill site. This inflexibility in nozzle geometry can prove disadvantageous where conditions change from location to location or change over time while the vessel operates at a particular spill site.

Although boom sprayer systems can sometimes be converted so that they will spray dispersants neat, the low rate of flow for the dispersant generates a very poor spray pattern. The low pressures which are associated with low flow rates create a situation where dispersant essentially dribbles from the nozzles. When the nozzle geometry of the boom sprayer is adjusted to get a better spray pattern, the sprayed dispersant becomes a very fine mist that is easily blown away by the wind without reaching the targeted area of the spill.

The ducted-fan air blower system injects dispersant into the focused air stream of a high speed fan. Dispersant is thereby propelled over a range of up to 100 feet. This kind of system typically has a pear-shaped shroud over the discharge side, inside which spray nozzles are strategically placed to allow for the greatest range consistent with reasonably uniform distribution of dispersant. Nevertheless, the spray distributed from this type of system is much less uniform than with a spray boom system.

The third principal type of system is a monitor system, typically used on vessels and land vehicles. In the context of hydraulic systems, a monitor is device for directing a relatively high pressure jet of water in a variable direction. The direction of spray is adjustable because the monitor connection swivels. Typically such a monitor is a swiveling elbow device for fluid flow such that the flow of fluid through the elbow can be directed in different directions by changing the angle of swivel. Such a monitor is frequently used with a suitable nozzle in water jet excavation of alluvial soil or mineral deposits. For the purposes of this application, a monitor is defined as such a flow-through swiveling device which is separate and distinct from a nozzle, though it may be attached either directly or indirectly to a nozzle.

Surface vessels typically use diluted dispersant systems because their slow speed of advance, compared to that of an aircraft, correlates to a much lower pumping rate for application of the desired amount of dispersant. Even though the desired total dose can be achieved from a surface vessel with dilution, field tests with vessels indicate that much lower rates of effectiveness are achieved with diluted application than with neat application of dispersants.

Monitor dispersant systems of the prior art, almost always used to spray dilute dispersant, comprise eductor units and commercially available monitors. Such systems typically bolt to the deck or floor of the host vehicle. A fluid hose or piping connects the monitor to a spray nozzle. An eductor or venturi draws concentrate dispersant into a stream of seawater at a rate of between 2 and 15 percent of the flow. The rate of output is controlled by the pumping rate or by bleeding off excess water to obtain the desired concentration of dispersant.

Monitor systems have been shown to be somewhat useful in spreading dilute dispersants over oil spills. Unfortunately, however, commercially available adjustable nozzles do not create uniform distributions of spray over the swath extending from the location of the nozzle to the full reach of the spray. Sometimes placing a 0.25 inch mesh screen over the orifice of a straight-stream commercially available nozzle causes the droplets to scatter more evenly. However, it is not particularly desirable to have to jury rig systems to achieve even a marginally desirable result.

Existing monitor systems do have some distinct advantages over boom sprayers in some circumstances. The monitor can be rotated to direct the spray toward the spill without the necessity of repositioning the vessel. In addition, because no appendage is suspended from the vessel, the system is more tolerant of rough water application. Tests performed in 1988 by Exxon found that vessels equipped with monitors spraying dilute dispersant, while less effective than application by conventional spray boom, projected further from the vessel than the reach of the boom, and allowed application at a much greater rate of speed of the vessel. Consequently, the conventional wisdom is that monitors are suitable for situations where treating the oil spill quickly is more important than achieving the highest effectiveness for each gallon of dispersant used.

From the standpoint of operational effectiveness, however, existing monitor systems have distinct drawbacks. Even as modified, the systems have been unable to achieve the level of spray uniformity of a boom sprayer. The monitor system also typically generates flow that hits the water at high velocity, driving the dispersant through the oil layer before it is able to react with it. Accordingly, existing monitor systems tend to be wasteful of dispersant. Moreover, pressure and velocity have been such that the systems have been unable to apply neat dispersants. Therefore, monitor units have been inappropriate for use with hydrocarbon solvent-based dispersants because predilution with water inactivates the surfactant.

Some monitor systems utilize the bilge or ballast pumps of the host vessel to pump seawater for mixing with the dispersant, which has a number of disadvantages in itself. First, use of an existing pump requires running hose through the vessel and closing manifold isolation valves to take the pump off line. Second, use of the pump for an intake can lead to contamination of the pump if oil from the spill is ingested. Third, use of a vessel pump may require a person to remain in the engine room to stop, start, and adjust the pump during the application process. Alternatively, a dedicated pump can be provided for use with the monitor system. However, because of the necessity to pump large quantities of diluting sea water, such a system is heavy and costly and substantially defeats the desirable portability of the system between vessels.

Another limitation has been that nozzles used to spray dilute dispersant are generally not able, for undiluted chemical dispersants, to achieve the appropriate droplet size distribution producing a gentle uniform rain as defined above. It has been known for some time in the art that droplet size, other conditions such as the nozzle configuration being held constant, is affected by the viscosity, volatility, and surface tension of the sprayed fluid. Thus a nozzle which produces a desirable droplet size distribution for water does not automatically produce the same droplet size distribution for other fluids with different viscosity, surface tension, and volatility. Conversely, Canevari, et al., U.S. Pat. No. 6,618,468, issued Apr. 8, 1997, indicates that viscosity, surface tension, and volatility of the dispersant composition are very important to the effective functioning of the composition when it comes in contact with the oil slick to be dispersed. In short, a nozzle which sprays water effectively is unlikely to spray neat chemical dispersant effectively in the circumstances of the current invention, and a suitable nozzle must be found.

Accordingly, an object of this invention is to provide a monitor-type oil spill dispersant application system that can be used to spray undiluted or neat dispersants upon an oil spill on the surface of water. A further object of this invention is to provide an oil spill dispersing system that can be moved easily between platforms and staged where it is needed, such as between land vehicles or waterborne vessels. A further object of this invention is to provide an oil spill dispersing system that can operate effectively in heavy weather involving rough seas. A further object of this invention is to provide an oil spill dispersing system that sprays a gentle uniform rain, somewhat like a drizzle, of dispersant. A further object of this invention is to provide an oil spill dispersing system that can be adjusted for different flow rates to suit different application conditions. A further object of this invention is to provide an oil spill dispersing system that is not wasteful of dispersant. A further object of this invention is to provide an oil spill dispersing system that can be directed manually toward the targeted area of the spill. A further object of this invention is to provide an oil spill dispersing system that is able to selectively treat areas of an oil spill according to thickness of the oil slick thereby removing the oil in one pass without the need for multiple passes of the vessel. A further object of this invention is to provide an oil spill dispersing system that can be placed quickly on virtually any vessel or land vehicle and be ready to operate within a very short period of time. Yet a further object of this invention is to provide, in combination with the other components of a system, a nozzle which will produce for undiluted or neat chemical dispersants a gentle uniform rain as defined above.

### SUMMARY OF INVENTION

The present invention is an apparatus for applying undiluted chemical dispersant to the upper surface of an oil spill on a body of water. Neat dispersant is applied in a gentle uniform rain. The apparatus can be used on either a waterborne vessel or on a land vehicle adjacent to the body of water. The apparatus optionally may be skid-mounted. The present invention accomplishes four things simultaneously: (1) the apparatus of the present invention disperses neat, that is to say undiluted, chemical dispersants of appropriately sized droplets which are (2) delivered uniformly over the area of the spray at (3) an appropriate velocity approximating a gentle uniform rain while (4) maximizing the range of distances over which the spray may be directed. The apparatus is configured to obtain the maximum oil dispersion for the minimum amount of dispersant used.

The present invention is also a method for treating waterborne oil spills with undiluted chemical dispersant in a uniform spray. The method is characterized by pressurizing the undiluted chemical dispersant to a pressure of between 50 and 200 psi and by spraying the pressurized undiluted dispersant onto the oil spill through a nozzle having a moving mechanical element configured to divide the liquid stream into droplets with a size distribution which minimizes the proportion of droplets less than 100 microns in size. In the preferred embodiment, the moving mechanical element is a rotating element with vanes or teeth which break the fluid up into droplets with the desired droplet size distribution.

The characterizing features of the apparatus are a source of pressurized dispersant, which optionally may be a pressure manifold, a monitor, a nozzle configured to distribute upon a predetermined area of the oil spill a pattern of gentle uniform rain consisting of a plurality of gently falling substantially uniform liquid droplets, such that the proportion of droplets less than 100 microns in size is minimized, optionally pipes or hoses connecting the manifold to the monitor, and optionally pipes or hoses connecting the monitor to the nozzle. The nozzle is further configured to produce liquid droplets of a size distribution such that the proportion of droplets less than 100 microns in size is minimized.

The nozzle of this invention is generally referred to as a “configured nozzle.” That means that the nozzle is configured to achieve a droplet size distribution where the proportion of droplets less than 100 microns in size is minimized. The nozzle has to be specially configured because, as previously noted, the droplet size distribution which comes from any give nozzle is highly dependent on the viscosity, surface tension, and volatility of the chemical dispersant fluid, so that the nozzle must in a sense match the properties of the dispersant, especially when it is a non-water based dispersant.

In the most highly preferred embodiment, the configured nozzle comprises a moving mechanical element configured to divide the liquid stream into droplets of substantially controlled minimum size. In the most highly preferred embodiment, the moving element in the nozzle is a rotating element with vanes or teeth such that rotating movement of the vanes or teeth breaks the liquid into droplets having the desired size distribution. As noted below, other kinds of nozzles are also usable variants for this invention. The invention also comprises a control to produce a variable flow rate so as to control selectively the volume of neat chemical dispersant applied.

The nozzle is hydraulically connected through a monitor and optionally through pipes or hoses to a source of pressurized dispersant, which may optionally be a pressure manifold. The apparatus is powered by a centrifugal pump hydraulically connected on its output side to the pressure manifold and optionally hydraulically connected on its input side to an inlet manifold. The pump receives and pressurizes the undiluted chemical dispersant by pumping the chemical dispersant into the pressure manifold whence it is conveyed through the monitor and thence to the configured nozzle having a moving element configured to divide the liquid stream into droplets having a size distribution in which the proportion of droplets less than 100 microns in size is minimized. The moving element in the preferred embodiment of the configured nozzle is a rotating element with vanes or teeth configured to break the liquid stream into droplets. The nozzle is also adjustable with respect to the flow rate so as to control the throughput of the undiluted chemical dispersant.

The apparatus optionally has at least a second configured nozzle hydraulically connected to the pressure manifold by way of a hose and optionally at least a second monitor. The inlet manifold of the apparatus is a multiple-inlet suction manifold, hydraulically cross connected to the pressure manifold, and the cross-connection element has a pressure relief valve. The apparatus optionally includes a reservoir containing a chemical dispersant pressurized to between 50 and 200 psi.

The apparatus also optionally includes a pressure manifold as a source of pressurized dispersant and a plurality of nozzles each having a rotating element with vanes or teeth configured to divide the liquid stream into droplets with a size distribution which minimizes the proportion of droplets less than 100 microns in size. The nozzles are hydraulically connected to the pressure manifold. Although the word “manifold” normally imports the sense of something with at least two branches, in this application the word is used in a more generic sense which also permits a single “branch” as well as plural branches. A centrifugal pump having an inlet and outlet side is hydraulically connected to the pressure manifold on its outlet side and, on its inlet side, is hydraulically connected to an inlet manifold. The pump receives and pressurizes the undiluted chemical dispersant by pumping the undiluted chemical dispersant into the pressure manifold from whence it is sprayed through the plurality of nozzles each having the rotating element. Alternatively, the pump may pump the chemical dispersant directly to the plurality of nozzles from whence it is sprayed upon the oil spill. The apparatus also optionally includes a reservoir containing pressurized chemical dispersant.

The present invention is more useful than any other dispersant application system now in existence to treat a wide variety of oil spills. It is able to spread effectively and efficiently, or distribute upon an oil spill, any neat dispersant including water based dispersants, hydrocarbon solvent-based dispersants, and concentrated dispersants. The ability to treat using neat dispersants, which are generally regarded to be more effective than dilute dispersants in treating oil spills, represents a decided advantage over existing monitor systems. Furthermore, unlike other systems using monitors, the present invention is able to treat spills using hydrocarbon solvent-based dispersants, which cannot be diluted with water before application.

In the skid-mounted configuration, which is intended to be portable, of the preferred embodiment, the apparatus typically would be situated on the bow of a vessel where the user or users have the greatest access to the area to be treated, although other on-deck locations may be chosen in particular situations. For example, in heavy seas, greater protection may be achieved for the user by placing the skid-mounted system aft. The relatively small size and portable nature of the invention allows great flexibility in this regard.

### BRIEF DESCRIPTION OF THE DRAWINGS

FIG. 1 shows a schematic view of the central elements of the invention.

FIG. 2 is a schematic line diagram showing the multiple nozzle and multiple dispersant embodiments of the invention.

FIG. 3 shows schematically the configuration of the preferred nozzle.

FIG. 4 shows the use of a pressure reservoir in conjunction with a configured nozzle.

### DESCRIPTION OF THE PREFERRED EMBODIMENT

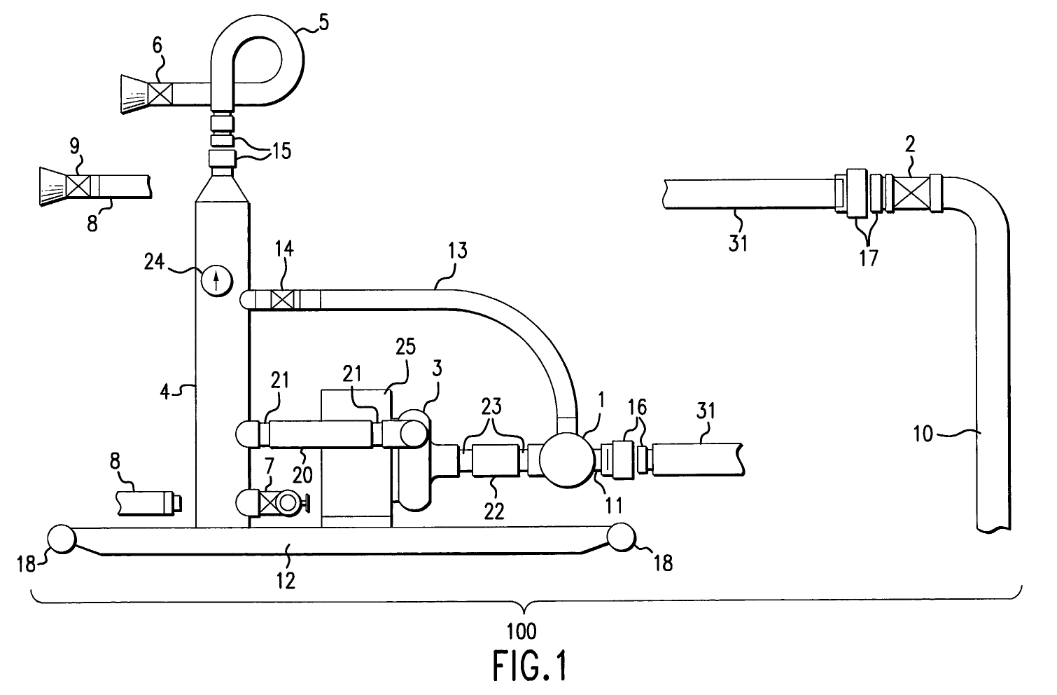

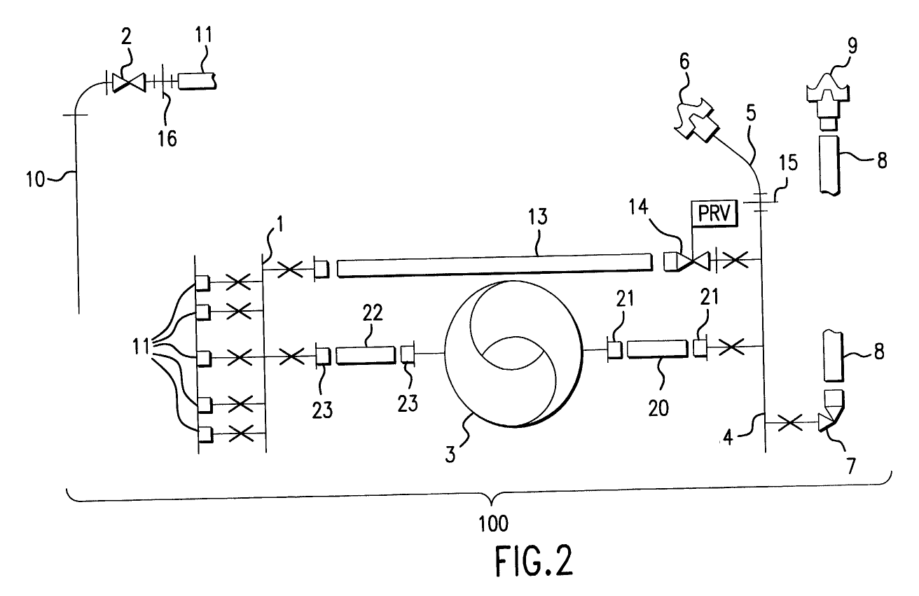

As shown in FIGS. 1 and 2, the preferred embodiment of the invention 100 incorporates an inlet manifold 1 through which dispersant enters the main pump 3 by way of nipples 23 and connector 22. That is, the dispersant is pumped through the inlet manifold 1 by the action of the pump 3 and thence through nipples 21 and hose connector 20 into the pressure manifold 4. From the pressure manifold 4, dispersant flows through a connector 15 into a monitor 5 and thence through a nozzle 6, from which it is sprayed onto the surface of an oil spill. Alternatively, upon opening a valve 7, dispersant may flow into a hose 8 and be dispersed through a second nozzle 9. Also alternatively, the pressure manifold 4 may be omitted and the pump connected directly to the monitor. The configured nozzles 6 and 9 are gentle uniform rain producing nozzles having a rotating element designed or configured to divide the liquid stream into droplets with a size distribution which minimizes the proportion of droplets less than 100 microns in size which are sprayed onto the oil spill.

Since the system is designed for use in the marine environment (either on a vessel or along the shore), all of the metallic components and fittings are preferably of non-corrosive materials such as aluminum, bronze, brass, copper or galvanized steel and are designed for marine use. Non-metallic components are chosen preferably for their compatibility with the marine environment and with the chemicals of the dispersants used by the system.

To provide a supply of dispersant to the apparatus, the user may insert a suction straw 10 into the tank or drum of dispersant and connect the suction straw to the inlet manifold 1 such that dispersant will be pulled from the drums into inlet manifold 1. Each suction straw 10 is fitted with a valve 2, which in the preferred embodiment is a 1.5 inch ball valve, that controls flow from the drum to inlet manifold 1. The valve 2 may be closed to shut off inlet from a drum after it has been emptied or to prevent any dispersant remaining in inlet manifold 1 from reentering suction straw 10 when the apparatus is shut down. Dispersant is typically supplied in 55 gallon drums. Therefore, the preferred embodiment provides for multiple simultaneous hookups of suction straws 10 to inlet manifold 1 via one or more inlet ports 11 and connectors 16 or other hydraulic connections so that the unit can be operated continuously when hydraulically connected to a multiplicity of 55 gallon drums (or similarly small receptacles) without the need to stop the process of application while tanks are changed. As configured in FIG. 2, inlet manifold 1 is a multiple-inlet suction manifold wherein up to five drums of dispersant may be hydraulically connected to the system simultaneously. For convenience, the preferred embodiment packages compatible suction straws 10 and flexible hoses 31 on skid 12 for use with the system.

Alternatively, the inlet manifold 1 can be replaced by a simple 2.5 inch tee having a single inlet port 11, a second port connecting to hose 13 or other hydraulic connector to pressure manifold 4, and a third port connecting to the pump 3. Such configuration would be used in situations where the object was to connect to a single large source of dispersant hydraulically to the apparatus. For example, where hydraulic connection was provided to dispersant in the cargo hold of a vessel in a water-based application or in the cargo tank of a tank truck in a land-based application. The inlet to the pump should be sized such that ample flow of dispersant is available to the pump during operation. For example, in the preferred embodiment, shown in FIG. 1, the connectors 16 and 17 are 2 inch Camlock Female, such that flexible hoses 31 may be inserted to run between the drums and the apparatus as necessary. Other sizes and type of valves or fittings are possible. The connector or fitting must be able to accept either a hose fitting or an appropriate fitting for another hydraulic connector attachment to the dispersant tank, and must be able to be closed off or sealed when a tank is not hydraulically connected.

In the preferred embodiment, pump 3 is a diesel-driven centrifugal pump. In one particular embodiment, centrifugal pump 3 is driven by a 9 horsepower motor 25 with a capacity of 210 gallons per minute (gpm) at a pressure of 117 pounds per square inch (psi). Centrifugal pump 3 has inlet and outlet orifices of 2.5 inches. Other pump capacities and other types of pumps are possible. The pump should be sized to provide an adequate flow of dispersant to all possible configured nozzles that the unit will supply. In the preferred embodiment, pump 3 provides dispersant flow rates adequate to supply either or both configured nozzles 6 and 9. Larger units having additional configured nozzles or configured nozzles of greater throughput capacity would require larger or more powerful motors and pumps; however, this could affect adversely the weight and portability of the system. Similarly, a less flexible unit having only a single configured nozzle, or having two or more configured nozzles of smaller throughput capacity, perhaps would be able to operate with a smaller motor and pump.

In the preferred embodiment, pressure manifold 4 is cross-connected by hose 13 or other hydraulic connector to the inlet manifold 1. In the preferred embodiment, backflow of dispersant through the hydraulic connection made by hose 13 between pressure manifold 4 and inlet manifold 1 is controlled by relief valve 14, which is set to 115 psi. Relief valve 14 ensures that backflow from pressure manifold 4 to inlet manifold 1 does not occur during normal operation unless excessive pressure builds up in pressure manifold 4. Relief valve 14 also allows the pump 3 to be started when configured nozzle 6 and monitor 5 are not connected and valve 7 serving configured nozzle 9 is closed without heat developing in pump 3 or losing pump prime. Pressure manifold 4 on the preferred embodiment is equipped with back mount gage 24 rated at 150 psi so that the user may observe the pressure in pressure manifold 4 to ensure that adequate pressure has developed before bringing nozzles 6 or 9 on line for spraying. This ensures that no dispersant is wasted due to inadequate pressurization being available to project the desired spray.

The hydraulic connection between pump 3 and pressure manifold 4 is made by the hose connector 20 or other hydraulic connector attached by the nipples 21. Hose connector 20 provides a flexible hydraulic connection that ensures that vibration from the pump 3 is not transmitted to the pressure manifold 4. A similar function is provided by the hose 13, being made of a flexible material. Either of these connections alternatively may be made by another type of hydraulic connector. Vibration transmitted directly to monitor 5 and nozzle 6 would have the potential to disturb the uniformity of the spray pattern or affect droplet size. In addition, vibration would pose a nuisance to the user operating the one or more configured nozzles 6 and 9. An ancillary advantage is ease of manufacturing, since alignment and fabrication difficulties are thereby avoided.

To operate the spraying unit, the user would adjust the orientation and angle of configured nozzle 6 and select its throughput or volume flow rate. The user would then start the motor for pump 3 and, when adequate pressure for the dispersant is achieved, open valve 7 or engage monitor 5 to begin spraying. Adjustments to nozzle orientation, angle, and flow rate, as well as to the speed and direction of the vessel, would be made during the application process to optimize the use of dispersant accounting for the shape and thickness of the area of the oil spill being treated. That is, each configured nozzle 6 and 9 is configured to distribute upon a predetermined area of an oil spill a pattern of gentle uniform rain comprising a plurality of liquid droplets that are substantially uniform in size so as to optimize the use of the dispersant.

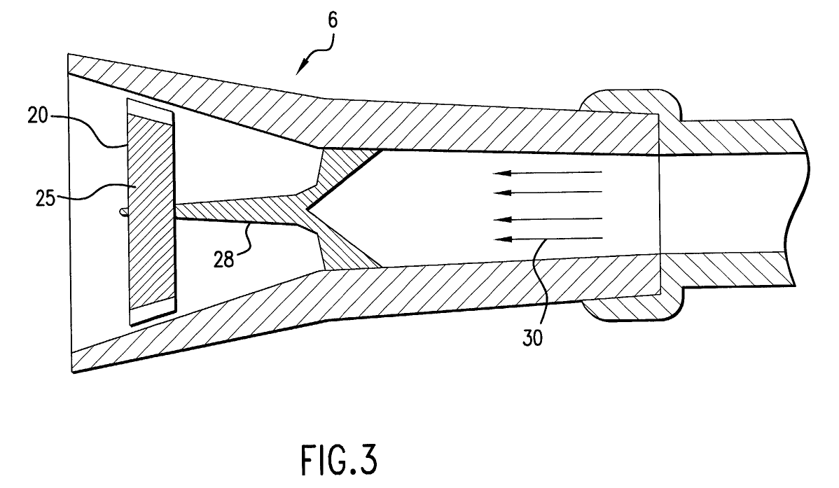

The preferred embodiment of the configured nozzle 6, which is mechanically identical to configured nozzle 9, is shown in modified cross section in FIG. 3. The pressurized liquid chemical dispersant 30 flows through the nozzle by way of a valve 29, which valve provides adjustability by regulating the dispersant flow rate. After passing through the valve 29, the dispersant passes through a strut 28, the primary purpose of which is to support the rotating mechanical element 27. The flow of the fluid against the vanes or teeth 26 turns the rotating mechanical element 27 and in turn the rotating motion breaks up the flowing fluid into droplets with the desired droplet size distribution.

The key enabling feature associated with the apparatus and method of this invention is the use of one or more gentle uniform rain producing nozzles such as the aforesaid configured nozzles—that is, nozzles 6 and 9 in the preferred embodiment, or additional nozzles as deemed appropriate. The nozzles 6 and 9, or other nozzles as might be used, are each specially configured with at least one moving mechanical element, in the most preferred embodiment a rotating mechanical element 27 with vanes or teeth 26 designed to divide the liquid dispersant stream into droplets with a size distribution that can be controlled by the flow rate and/or by the configuration of the nozzle. Otherwise stated, each configured nozzle 6 and 9 is chosen by design and further adjusted during operation to produce on, or distribute upon, a predetermined area of an oil spill a pattern of gentle uniform rain, the droplets of which are relatively uniform in size and which minimize the proportion of droplets less than 100 microns in diameter.

In the preferred embodiment, the configured nozzles 6 and 9 are 1.5 inch by 1 inch variable flow nozzles manufactured by Akron Brass that adjust to allow application of dispersant at a constant flow rate of 13, 25, 40, or 60 gpm. Spinning or rotating vanes or teeth in the Akron Brass nozzles break up the fluid stream into a gentle uniform rain while pattern detents assist in positioning the spray pattern. The Akron Brass nozzles selected for use in this invention were designed for high pressure applications where the amount of fluid available for dispersal would be limited. The Akron Brass nozzles were chosen because of their ability to produce a uniform spray coverage over a wide area and produce droplets in the desired size range. The literature produced by Akron Brass does not suggest, however, that these nozzles will produce droplet sizes appropriate for this application and, indeed, makes no mention that these nozzles would be able to spray chemical dispersants, owing to the fact that the nozzles were designed to spray water and Class A and Class B firefighting foams which have different viscous properties than chemical dispersant. Other configured nozzles 6 and 9 permitting user selection of different flow rates or exhibiting different geometries of their rotating mechanical element 27 and vanes or teeth 26 may prove desirable in other dispersant application scenarios. Such other nozzles include the Greenleaf Technologies “Turbo-Drop Venturi” nozzle normally used for pesticides in agricultural applications, the “AirJet®” nozzle manufactured by Spraying Systems of Wheaton, Ill. and the “Shear GuardTM PLUS” manufactured by Spray-Air USA, Inc. of Grangeville, Idaho, also used for agricultural applications.

The ability to select between flow rates enhances the flexibility of the system to treat a wide variety of spills. The user would select a desired flow rate by adjusting the valve 29 on configured nozzle 6 or 9. Selection of flow rate would depend on the thickness and viscosity of the oil, the ambient conditions of sea and air (including water temperature, wave conditions, and wind speed and direction), the speed of the vessel, the type and concentration of the dispersant, and the desired sweep width.

The specific combination of configured nozzles 6 and 9 was selected to facilitate users in aiming the fluid stream precisely to hit specific spots while retaining tight control over flow rate, thereby maximizing the effectiveness of limited amounts of fluid to be dispersed. That is, the preferred embodiment envisions that the primary spill treatment will be provided by the first nozzle 6, while the second nozzle 9 could be brought on line in a variety of ways that increase the flexibility of the system. In one scenario, the use of the second nozzle 9 could allow the user to apply dispersant from both sides of the vessel at the same time, thereby doubling the sweep width. Alternatively, the second nozzle 9 could be used for touching up particular spots that were not completely cleared by the first sweep of the first nozzle 6. Alternatively, the flows from both configured nozzles 6 and 9 could be directed at a particular area in tandem to increase the amount of dispersant being applied in a given area. It would also be possible to operate the system only using nozzle 9 by keeping nozzle 6 off line. More importantly, while employing a first configured nozzle 6 or 9, the second configured nozzle could be brought on line to perform any or all of the aforesaid functions at particular times during the application process without the need to stop or restart the system.

In the preferred embodiment using a skid-mounted configuration, having one fixed and one hose-mounted nozzle allows the unit to spray dispersant from both sides of the vessel while keeping skid 12 to a modest size. Hose 8 allows nozzles 9 and 6 to operate from opposite sides of the vessel. Other hydraulic connectors may be substituted for monitor 5 or hose 8 to suit particular applications. For instance, in an alternative embodiment where a permanent vessel-mounted installation is effected, both nozzles might mount on monitors affixed to opposite sides of the vessel. In that installation, it might further prove desirable to have hook-ups available to support one or more hose installations as well, so that the same level of flexibility could be achieved as with the skid-mounted system.

The system pumps only neat dispersants, therefore both the volume that must be pumped and the rate of pumping are relatively modest. One practical effect of this is that pump 3 can be relatively small and lightweight. Another practical effect is that the user is able to hold either nozzle 6 or 9 with ease and direct the flow manually. This attribute is particularly important to the utility of nozzle 9 which, in the preferred embodiment, operates without supporting structure. The invention's ability to allow the user free control of dispersant flow rate and spray orientation provides a degree of directional and distance flexibility that was not previously possible. The maximum reach of the present invention (up to 131 feet) is an order of magnitude greater than the maximum reach of existing hand-held systems (typically consisting of a fan- or cone-shaped spray nozzles attached to a spray lance or spray wand), which is on the order of 10 to 15 feet.

In the preferred embodiment shown in FIGS. 1 and 2, the configured nozzle 6 is mounted on the monitor 5. Monitor 5 is 1.5 inch and attaches to pressure manifold 4 via connector 15, a 2 inch Camlock male/female joint. This allows monitor 5 and nozzle 6 to be removed from pressure manifold 4 to prevent damage during shipment. Valve 7, a 1.5 inch angle valve acts as a shutoff for nozzle 9. Hose 8 is a 1.5 inch diameter 50-foot industrial quality hose. Hose 8 acts as the hydraulic connector for nozzle 9. The length of hose 8 determines how far configured nozzle 9 can operate from nozzle 6 or from the unit itself. It is desirable to make hose 8 of sufficient length to allow operation of nozzle 9 on the opposite side of the vessel from nozzle 6. Other configurations are possible and may prove desirable in certain applications. For instance, both nozzles could be attached to pressure manifold 4 via hose connections rather than having nozzle 6 mounted on a monitor. Fixed operation could be achieved by adding a mounting cradle for each nozzle to skid 12 that would act to secure the location, angle and orientation of either or both nozzles in one mode of operation while adding flexibility by enabling both nozzles to operate from locations remote to the system as required.

Since the present invention has a larger effective sweep than boom sprayers and application can be undertaken at significantly higher vessel speeds, large spills can be treated much more quickly and effectively than they can with boom sprayers. The present invention, configured with the centrifugal pump 3 and the configured nozzles 6 and 9 as described hereinabove in the preferred embodiment, is able to treat much larger swaths than a typical spray boom system, which is the only existing type of vessel-based system capable of applying neat dispersants. Vessel-mounted spray boom systems typically use a 20- to 30-foot boom mounted on each side of the vessel. Assuming a vessel beam between 24 feet and 60 feet, a boom sprayer sweeps about 44 to 90 feet. In comparison, the present invention as configured has a maximum reach of 131 feet from a single configured nozzle 6 or at high volume, which is 60 gpm. Optimizing the spray pattern for uniformity of distribution at 60 gpm yields a reach of 60 feet per side. Thus, with both nozzles 6 and 9 operating at 60 gpm, each nozzle operating on one side of the vessel, the present invention will sweep between 144 and 184 feet, depending on the beam of the vessel. Varying the application rate also varies the sweep width. However, even operating at the reduced application rate of 13 gpm, two sides dispersing in an optimum pattern will sweep between 104 and 140 feet depending on the width of the vessel, which is still significantly more than can be achieved using a boom sprayer.

Boom sprayers are typically operated at vessel speeds in the range of 2 to 5 knots whereas, using the present invention, effective treatment can be achieved at vessel speeds of up to 20 knots. This means that the present invention could treat a given spill area between 4 and 10 times faster than a boom sprayer. This result is enhanced by the significantly greater sweep associated with the present invention which, depending on the scenario, can be as much as two or three times the sweep of the boom sprayer.

The system 100 according to the present invention is conveniently packaged on the skid 12. A battery, not shown, may be attached to the skid 12 to facilitate electric starting of the motor 25 of the pump 3. In the preferred embodiment, the skid 12 is provided with attachment points 18 that can be used to lift the system on and off a vessel. A storage box, not shown, may also be attached to skid 12 so that nozzles 6 and 9 can be stored to prevent loss or damage during shipment and so that personal protective gear, monitoring devices, small spare parts, and other items can be stored for convenient access. Hoses 8 and 31, or other similarly sized hydraulic connectors, may be coiled and set on top of pump 3 in skid 12 for shipment. In this way, system 100 is entirely self-contained and ready to be set-up and operated immediately after it is placed on the vessel or vehicle platform.

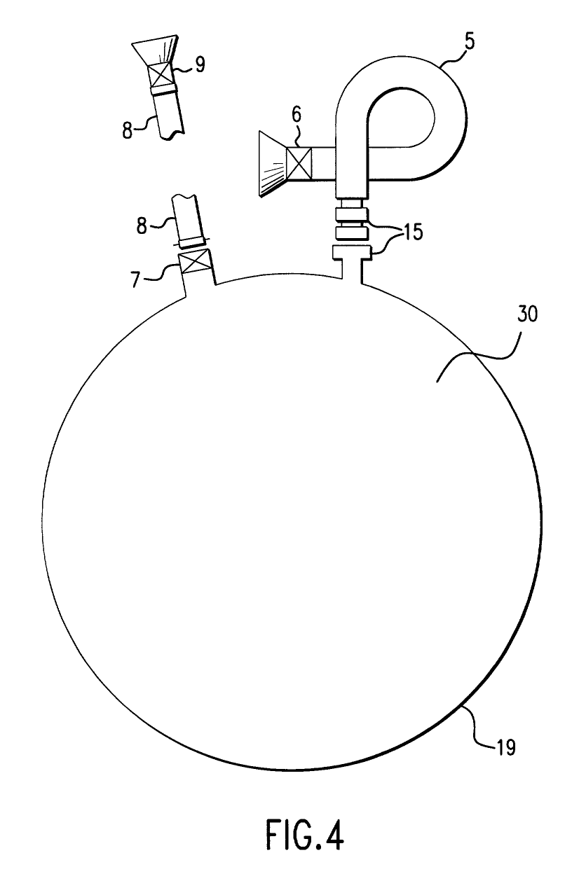

Pressure manifold 4 in an alternative embodiment could be any reservoir of pressurized chemical dispersant, as illustrated in FIG. 4. For example, one or more gentle uniform rain producing nozzles such as the configured nozzles 6 and 9 herein described mounted either on a monitor 5 or other hydraulic connection such as hose 8 may be fed from a reservoir of pressurized chemical dispersant consisting of a pressure chamber 19 containing pressurized liquid chemical dispersant 30. Such an embodiment could be envisioned for either application using a land vehicle or a vessel as the host platform. Where the configured nozzles 6 and 9 as in the preferred embodiment were selected, pressure in the pressure chamber 19 should be in the range of 50 to 200 psi, and would more preferably be regulated to provide constant safe working pressure of between approximately 75 and 150 psi. Pressures less than 50 psi would be inadequate to generate the desired spray pattern at the nozzles. Although the nozzles 6 and 9 are rated to withstand pressures in excess of 500 psi, very high pressures would produce spray that fails to settle gently and uniformly on the oil's surface.

I claim:

1. An apparatus for depositing fluid chemical dispersant on an oil spill in a gentle uniform rain, said apparatus comprising
a. at least one configured nozzle, said nozzle being configured to divide fluid chemical dispersant into a gentle uniform rain; and
b. a source of pressurized fluid chemical dispersant;
c. said source and said at least one configured nozzle being hydraulically connected.

2. The apparatus of claim 1 wherein the source of pressurized fluid chemical dispersant comprises a pressurized reservoir.

3. The apparatus of claim 2 wherein the pressurized reservoir is pressurized to between about 50 psi and about 200 psi.

4. The apparatus of claim 1 wherein the source of pressurized fluid chemical dispersant comprises a pump hydraulically connected to at least one container of fluid chemical dispersant.

5. The apparatus of claim 4 wherein the source of pressurized fluid chemical dispersant comprises a pump having an inlet side and an outlet side, the inlet side of which is hydraulically connected to an */unpressurized source of fluid chemical dispersant and the outlet side of which is hydraulically connected to a pressure manifold, the pressure manifold being in hydraulic connection with the configured nozzle.

6. The apparatus of claim 1 wherein a pressure manifold establishes hydraulic connection between the source of pressurized fluid chemical dispersant and said at least one configured nozzle.

7. The apparatus of claim 6 wherein at least one of the at least one nozzle is connected to the pressure manifold by a hose.

8. The apparatus of claim 6 wherein at least one monitor hydraulically connects the at least one configured nozzle to the pressure manifold.

9. The apparatus of claim 1 wherein an at least one monitor establishes the hydraulic connection between the at least one configured nozzle and the source of pressurized fluid chemical dispersant.

10. The apparatus of claim 9 wherein the source of pressurized fluid chemical dispersant comprises a pump hydraulically connected to an inlet manifold, said inlet manifold being hydraulically connected to at least one source of unpressurized fluid chemical dispersant.

11. The apparatus of claim 10 additionally comprising a hydraulic cross-connect between the inlet manifold and the pressure manifold.

12. The apparatus of claim 1 in which the configured nozzle additionally has an adjustable flow rate.

13. The apparatus of claim 12 in which the adjustable flow rate is between 13 and 75 gallons per minute.

14. The apparatus of claim 1 wherein the configured nozzle has a moving element which divides the fluid chemical dispersant into droplets so as to produce a gentle uniform rain.

15. The apparatus of claim 14 wherein the moving element which divides the fluid chemical dispersant into droplets so as to produce a gentle uniform rain comprises a rotating element with vanes or teeth.

16. The apparatus of claim 10 wherein the inlet manifold comprises a multiple suction manifold.

17. The apparatus of claim 1 in which the fluid chemical dispersant is undiluted.

18. The apparatus of claim 1 wherein the configured nozzle additionally comprises an adjustable spray pattern.

19. A method for treating oil spills with fluid chemical dispersant comprising the steps of:
a. pressurizing the fluid chemical dispersant;
b. conducting the fluid chemical dispersant through a configured nozzle;
c. whereby the fluid chemical dispersant is sprayed in a gentle uniform rain.

20. The method of claim 19 in which the step of pressurizing the fluid chemical dispersant produces pressures in the range of about 50 to about 200 psi.

21. The method of claim 19 in which the configured nozzle is configured to divide fluid chemical dispersant into a gentle uniform rain.

22. The method of claim 21 in which the configured nozzle configured to divide fluid chemical dispersant into a gentle uniform rain comprises a moving element.

23. The method of claim 22 in which the moving element is a rotating element with vanes or teeth.
